(19) United States
(12) Patent Application Publication
(10) Pub. No.: US 2012/0311179 A1
(43) Pub. Date: Dec. 6, 2012

(54) METHOD FOR PROCESSING TCP RE-TRANSMISSION BASED ON FIXED ADDRESS

(75) Inventors: BONGJUN HUR, Yongin (KR); JUNGTAE LEE, Busan (KR); JUNWOO RYU, Yongin (KR); JAEHO LEE, Sungnam (KR); SOOHWAN KIM, Yongin (KR); YOUNGSU LEE, Sungnam (KR)

(73) Assignee: WIZNET CO.,LTD., Seongnam (KR)

(21) Appl. No.: 13/295,042

(22) Filed: Nov. 12, 2011

(30) Foreign Application Priority Data
Nov. 18, 2010 (KR) 10-2010-0115086

(51) Int. Cl. G06F 15/16

(52) U.S. Cl. 709/234

(57) ABSTRACT

The present invention relates to a technology where, in the state that start pointers for n transmit buffers each having Ethernet frame size are fixedly declared and thus fixed addresses are assigned to the transmit buffers, packets can be stably retransmitted utilizing the fixed addresses of the transmit buffers, without executing dynamic pointer operations in re-transmission.

### CROSS-REFERENCE TO RELATED APPLICATION

This application claims priority under 35 U.S.C. §119 from Korean Application No. 10-2010-0115086 filed on Nov. 18, 2010, the subject matter of which is incorporated herein by reference.

### BACKGROUND

1. Technical Field

The present invention relates to a method for processing TCP re-transmission based on the fixed address, more specifically, a technology where, in the state that start pointers for n transmit buffers each having Ethernet frame size are fixedly declared, packets can be simply retransmitted based on the fixed addresses due to fixed start pointers, without executing dynamic pointer operations in re-transmission.

2. Background Art

As exemplary protocol for controlling information transmission of networks, TCP (Transmission Control Protocol) is present. The TCP is a communication protocol that connects computers having different systems from each other on the basis of IP (Internet Protocol) and is used for transmission of data.

If transmitter terminal transmits the data dividing it into packet units, the TCP recombines the packets received by receiver terminal to restore the original data. If each packet is received, the receiver terminal transmits acknowledgement signal to the transmitter terminal, thereby informing that all packets for the relevant data have been successfully received. If the acknowledgement signal is not received, the transmitter terminal retransmits the packet until the acknowledgement signal is received from the receiver terminal.

In general, the TCP is embodied by protocol stack and installed on a communication system. In the case that the TCP is installed on Linux and embedded system, the Linux and embedded system have a plurality of transmit buffers of Ethernet frame size for re-transmission. Since Ethernet frames corresponding to size of transmit buffer are stored in advance, if the acknowledgement signal is not received from the receiver terminal, the transmitter terminal may transmit the relevant packet in the transmit buffer to the receiver terminal.

In the process of such re-transmission, scheduling algorithm for storing a plurality of transmitted data(packet) in the transmit buffers and transmitting the data stored in the transmit buffers, and dynamic start pointer operations for the transmit buffers are needed. The scheduling algorithm for the transmit buffers causes a complexity of the system to be increased and the dynamic pointer operations for the transmit buffers may increase unstable elements of the system due to the pointer operations.

### SUMMARY OF THE INVENTION

The present invention is devised in view of the above-mentioned situations, and its object is to simplify the scheduling algorithm for the transmit buffers and pointer operations of the transmit buffers to improve operation of the system by setting size of the n transmit buffers each having Ethernet frame size by n×Ethernet frame and fixedly declaring a point where n^{th} transmit buffer starts as a start pointer of n^{th} transmit buffer to thereby assign a fixed address to the n^{th} transmit buffer.

A method for processing TCP re-transmission based on the fixed address according to the present invention may comprise (a) a step of setting a plurality of transmit buffers having a fixed address; (b) a step of storing the k^{th} data in the n^{th} transmit buffer of the transmit buffers where writing prohibition flag is cleared and setting the writing prohibition flag of the n^{th} transmit buffer; (c) a step of transmitting the k^{th} data to a receiver terminal and determining whether acknowledgement signal for the k^{th} data has been received; and (d) a step of clearing the writing prohibition flag of the n^{th} transmit buffer if the acknowledgement signal has been received and retransmitting the k^{th} data stored in the n^{th} transmit buffer if the acknowledgement signal has not been received within a predetermined period of time.

Preferably, in the step (a) of the present invention, each transmit buffer is set by Ethernet frame size, and a start pointer of each of the transmit buffers is fixedly declared and thus each transmit buffer may have a fixed address.

Preferably, the step (b) of the present invention may comprise a step of scanning each writing prohibition flag of the plurality of the transmit buffers to search a transmit buffer where the writing prohibition flag is cleared if the k^{th} data to be transmitted is inputted; a step of storing the k^{th} data in the n^{th} transmit buffer if the n^{th} transmit buffer is searched where the writing prohibition flag is cleared; and a step of setting the writing prohibition flag of the n^{th} transmit buffer.

Preferably, in the step (d) of the present invention, if the acknowledgement signal for the k^{th} data has been received, the writing prohibition flag of the n^{th} transmit buffer may be cleared after searching n^{th} transmit buffer by use of the fixed address of the n^{th} transmit buffer.

Preferably, in the step (d) of the present invention, if the acknowledgement signal for the k^{th} data has not been received, the k^{th} data stored in the n^{th} transmit buffer may be retransmitted after searching the n^{th} transmit buffer by use of the fixed address of the n^{th} transmit buffer.

### ADVANTAGEOUS EFFECTS

The present invention has an effect that it can simplify the scheduling algorithm for the transmit buffers and pointer operations of the transmit buffers to improve operation of the system by setting size of the n transmit buffers each having Ethernet frame size by n×Ethernet frame and fixedly declaring a point where n^{th} transmit buffer starts as a start pointer of n^{th} transmit buffer to thereby assign a fixed address to the n^{th} transmit buffer.

### BRIEF DESCRIPTION OF THE DRAWINGS

Arrangements and embodiments may be described in detail with reference to the following drawings in which like reference numerals refer to like elements and wherein

FIG. 1 is a functional block diagram of a system carrying out a method for processing TCP re-transmission based on the fixed address according to the example of the present invention.

FIG. 2 is a view exemplarily illustrating structure of transmit buffers and declaration of a start pointer applied to the method for processing TCP re-transmission based on the fixed address according to the example of the present invention.

FIG. 3 is a flowchart exemplarily explaining the method for processing TCP re-transmission based on the fixed address according to the example of the present invention.

FIG. 4 is a data flow diagram exemplarily explaining the method for processing TCP transmission based on the fixed address according to the example of the present invention.

FIG. 5 is a view showing a conventional structure of TCP packet.

FIG. 6 is a data flow diagram exemplarily explaining the method for processing TCP re-transmission based on the fixed address according to the example of the present invention.

### LISTS OF REFERENCE NUMERALS IN THE DRAWINGS

10: transmit buffer initializing part
20: transmit buffer scanning part
30: transmit buffer data processing part
40: transmit buffer lock controlling part
50: data transmitting part
60: acknowledgement processing part.

### DETAILED DESCRIPTION OF THE INVENTION

Hereinafter, an example of the present invention will be described in detail with reference to the attached drawings.

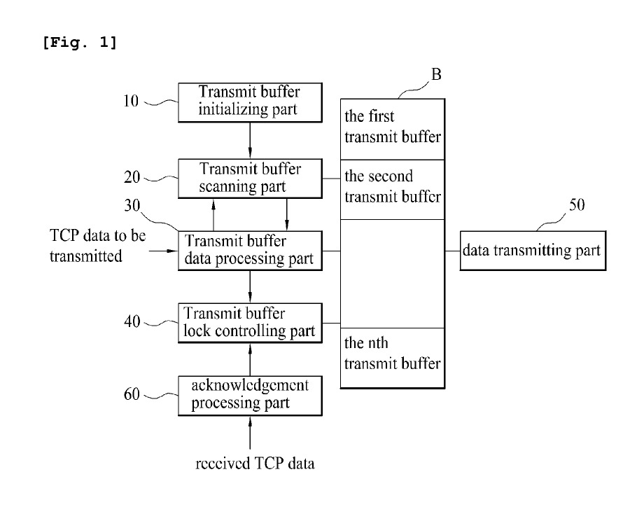

FIG. 1 is a functional block diagram of a system carrying out a method for processing TCP re-transmission based on the fixed address according to the example of the present invention.

As shown in FIG. 1, the system for processing TCP re-transmission based on the fixed address according to the example of the present invention comprises a transmit buffer initializing part (10), a transmit buffer scanning part (20), a transmit buffer data processing part (30), a transmit buffer lock controlling part (40), a data transmitting part (50) and an acknowledgement processing part (60).

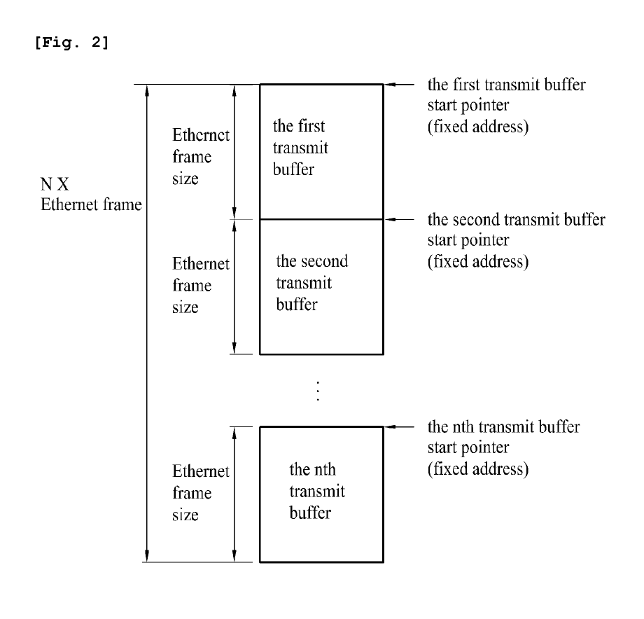

As shown in FIG. 2, the transmit buffer initializing part (10) initializes the size of the transmit buffer such that storage is made possible by division into n Ethernet frames taking Ethernet frame size as a unit. N transmit buffers (B) all have the same size, and a point where n^{th transmit buffer starts is declared as start pointer of n}^{th} transmit buffer. Therefore, the n^{th} transmit buffer has a fixed address (i.e., start pointer). In the example of the present invention, since the transmit buffer has the fixed address, it is not necessary to perform pointer operations by dynamically assigning the pointer, as opposed to prior art. The transmit buffer initializing part (10) transmits the fixed address of the declared n^{th} transmit buffer to the transmit buffer scanning part (20).

The transmit buffer (B), in which the pointer is declared, is provided with writing prohibition flag for indicating a condition of writing prohibition.

The transmit buffer scanning part (20) scans the n transmit buffers in order and then searches the writing prohibition flag of each transmit buffer. According to the result of the search, transmitted to the transmit buffer data processing part (30) is an information of the transmit buffer (i.e., the i^{th} transmit buffer) where the writing prohibition flag is cleared.

If TCP data to be transmitted is received from upper class (i.e., TCP/IP 4 class), the transmit buffer data processing part (30) instructs the transmit buffer scanning part (20) to scan the transmit buffer. If information of the transmit buffer is received from the transmit buffer scanning part (20) as a response of the instruction, TCP data is stored in the i^{th} transmit buffer corresponding to the information of the transmit buffer. After TCP data has been stored, the transmit buffer data processing part (30) instructs the data transmitting part (50) to transmit the TCP data to the i^{th} transmit buffer. Furthermore, the transmit buffer data processing part (30) transmits information (for example, start pointer information) of the transmit buffer where the TCP data is stored and information (sequence number and acknowledgement number) about the TCP data to the acknowledgement processing part (60), and thereafter acknowledgement of the TCP data stored in the i^{th} received buffer is implemented by the acknowledgement processing part (60).

The transmit buffer lock controlling part (40) sets the writing lock flag of the i^{th} transmit buffer to a lock based on the information of the i^{th} transmit buffer transmitted from the transmit buffer data processing part (30). Furthermore, if the information of the i^{th} transmit buffer is transmitted from the acknowledgement processing part (60), the transmit buffer lock controlling part (40) clears the writing lock flag of the i^{th} transmit buffer. That is, the transmit buffer lock controlling part (40) sets the writing lock flag of the transmit buffer (B) based on the information of the transmit buffer transmitted from the transmit buffer data processing part (30), and clears the writing lock flag of the transmit buffer (B) based on the information of the transmit buffer transmitted from the acknowledgement processing part (60).

The data transmitting part (50) is a block that transmits the TCP data (i.e., Ethernet package) stored in the i^{th} transmit buffer according to the instruction of the transmit buffer data processing part (30), and reads the TCP data from the i^{th} transmit buffer to transmit to receiver side by using the information of the transmit buffer transmitted from the transmit buffer data processing part (30). Furthermore, the data transmitting part (50) performs re-transmission of the TCP data stored in a specific transmit buffer where acknowledgement signal is not received within a predetermined period of time according to instruction of the acknowledgement processing part (60).

The acknowledgement processing part (60) determines whether the acknowledgement signal of the sent data has been received by utilizing the TCP data received from receiver terminal, and according to the result of the determination, controls the transmit buffer lock controlling part (40) and the data transmitting part (50). More specifically, the acknowledgement processing part (60) extracts the sequence number/acknowledgement number from the received TCP data and then compares it with the sequence number/acknowledgement number transmitted from the transmit buffer data processing part (30), and thereafter if coinciding numbers are present, transmits to the transmit buffer lock controlling part (40) the information of the transmit buffer where the TCP data corresponding to the relevant sequence number and acknowledgement number is stored, whereby the transmit buffer lock controlling part (40) clears the writing prohibition flag of the relevant specific transmit buffer.

The acknowledgement processing part (60) incorporates a time-out processing part, and counts waiting time until the acknowledgement signal for the specific TCP data is received, and if the waiting time for acknowledgement signal exceeds a predetermined period of time, instructs the data transmitting part (50) to retransmit the TCP data.

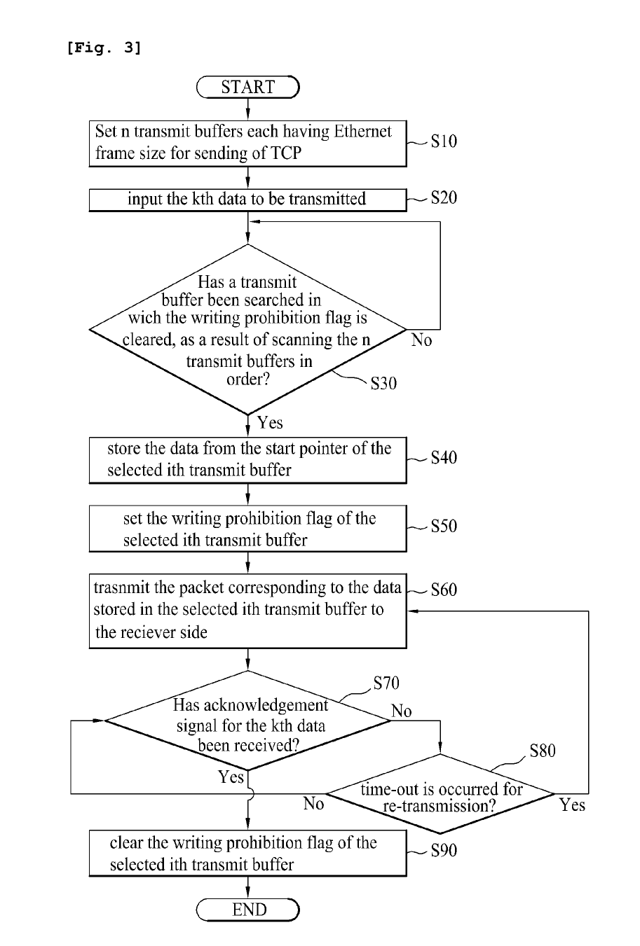

Next, referring to a flowchart illustrated in FIG. 3, detailed description will be made of the method for processing TCP re-transmission based on the fixed address according to an example of the present invention.

The transmit buffer initializing part (10) sets n transmit buffers of Ethernet frame size in order to send TCP (S10). For each transmit buffer set in step S10, the start pointer is declared such that the transmit buffer has a fixed data size. In this connection, the declared start pointer (i.e., fixed address) is fixed. The transmit buffer initializing part (10) transmits information about the set transmit buffer to the transmit buffer scanning part (20).

If the TCP data (for example, the k^{th} data) to be transmitted is received from upper class i.e., TCP/IP class (S20), the transmit buffer data processing part (30) instructs the transmit buffer scanning part (20) to scan the transmit buffer.

Responding to the instruction, the transmit buffer scanning part (20) scans n transmit buffers in order and then searches the transmit buffer where the writing prohibition flag is cleared (S30). As a result of the search, if the writing prohibition flags of all of the n transmit buffers are set and thus the cleared writing prohibition flag is not searched (‘No” in S30), the transmit buffer scanning part (20) continues to execute the step S30.

In contrast, as a result of the search in step S30, if the writing prohibition flag of the i^{th} transmit buffer of n transmit buffers is searched to be cleared (“Yes” in S30), the transmit buffer scanning part (20) returns information (for example, fixed address) about the i^{th} transmit buffer to the transmit buffer data processing part (30). This transmit buffer data processing part (30) stores the TCP data corresponding to the k^{th} data from the start pointer of the selected i^{th} transmit buffer (S40).

If storage of the TCP data is completed, the transmit buffer data processing part (30) transmits the information about the i^{th} transmit buffer to the transmit buffer lock controlling part (40), and transmits to the acknowledgement processing part (60) the sequence number/acknowledgement number extracted from the TCP. Furthermore, the transmit buffer data processing part (30) instructs the data transmitting part (50) to transmit the TCP data stored in the i^{th} transmit buffer. For reference, the acknowledgement number is a value produced as a data length corresponding to the sequence number and TCP data.

The transmit buffer lock controlling part (40) sets the writing prohibition flag of the i^{th} transmit buffer of the transmit buffers (B) based on the transmitted information about the i^{th} transmit buffer (S50).

Responding to the instruction, the data transmitting part (50) reads data from the start pointer of i^{th} transmit buffer of the transmit buffers (B) to transmit TCP packet corresponding to the read data to the receiver side (S60).

Meanwhile, the acknowledgement processing part (60) stores the sequence number and acknowledgement number transmitted from the transmit buffer data processing part (30), and if the TCP data is received, extracts the sequence number/acknowledgement number from the received TCP data and then compares it with the previously stored sequence number/acknowledgement number, thereby determining whether the acknowledgement signal for the k^{th} data has been received (S70).

In step S70, if sequence number/acknowledgement number from the received TCP data are present among the previously stored sequence number/acknowledgement, the acknowledgement processing part (60) determines that the acknowledgement signal for the k^{th} data has been received (“Yes” in S70). In contrast, if the sequence number/acknowledgement number from the received TCP data are not present among the previously stored sequence number/acknowledgement, the acknowledgement processing part (60) determines that the acknowledgement signal for the k^{th} data has not been received (“No” in S70).

If the acknowledgement signal for the k^{th} data has not been received in step S70, the acknowledgement processing part (60) determines whether the time-out is occurred for re-transmission (S80). As a result of the determination in S80, if it is determined that the time-out is occurred (“Yes” in S80), the process proceeds to step S60 to instruct the data transmitting part (50) to re-transmit the k^{th} data stored in the i^{th} transmit buffer. In contrast, as a result of the determination in S80, if it is determined that the time-out is not occurred (“No” in S80), the process proceeds to step S70 to determine whether the acknowledgement signal for the k^{th} data has been received.

Meanwhile, if it is determined in S70 that the acknowledgement signal for the k^{th} data has been received, the acknowledgement processing part (60) transmits information about the i^{th} transmit buffer storing the k^{th} data to the transmit buffer lock controlling part (40). The transmit buffer lock controlling part (40) clears the writing prohibition flag of the i^{th} transmit buffer (S90).

In the flowchart illustrated in FIG. 3, the case of the k^{th} data being inputted has been described as an example, but steps S30 to S90 can be carried out in parallel also for the next data following in order (for example, the k+1^{th} data, the k+2^{th} data and the k+3^{th} data) inputted during a period when the steps S30 to S90 are carried out.

In the above case, if the k+1^{th} data is inputted with the writing prohibition flag of the n^{th} received buffer storing the k^{th} data being set, the k+1^{th} data will not be able to be stored in the n^{th} received buffer. However, in the state that the acknowledgement for the k^{th} data has been completed and thus the writing prohibition flag of the n^{th} received buffer is cleared, if the k+2^{th} data is inputted, the k+2^{th} data may be stored in the n^{th} received buffer.

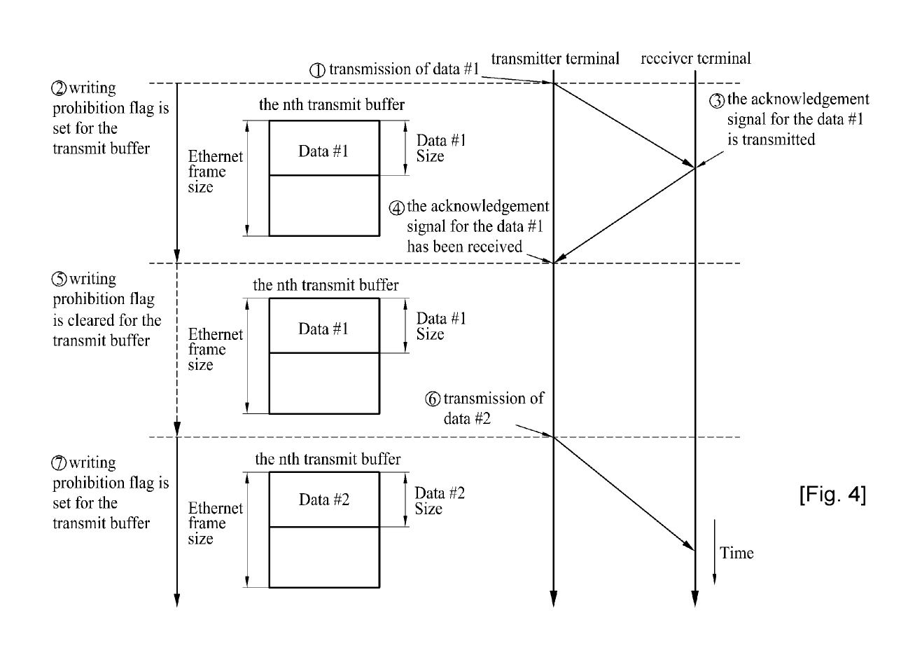

FIG. 4 is a view exemplarily illustrating a process for transmitting the TCP data carried out in a method for processing TCP re-transmission based on the fixed address according to an example of the present invention.

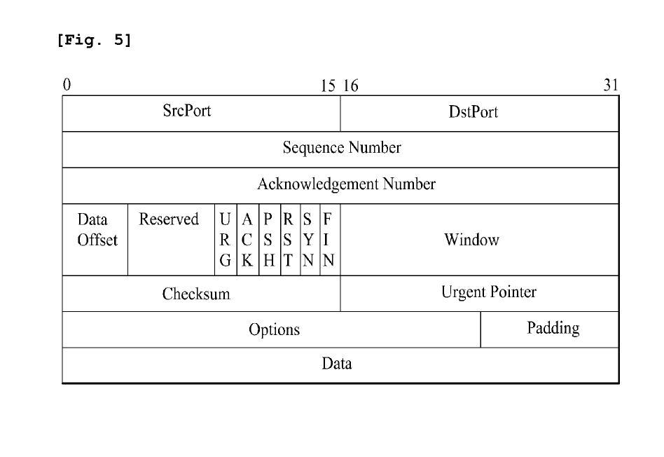

Referring to FIG. 4, if data #1 is stored in the n^{th} transmit buffer, the sending terminal to which the present invention is applied transmits the data #1 to a receiving terminal (\textcircled{1}), and the writing prohibition flag is set for the n^{th} transmit buffer (\textcircled{2}). At this time, the transmitter terminal stores the sequence number and acknowledgement number of the data #1. As shown in FIG. 5, these sequence number and acknowledgement number are defined for standard of the TCP packet, and the acknowledgement number is a value produced from the sequence number and data length.

If the data #1 is normally received, the receiving terminal transmits the acknowledgement signal for the data #1 (\textcircled{3}), the acknowledgement signal includes the sequence number and acknowledgement number.

The sending terminal extracts the sequence number and acknowledgement number from the received acknowledgement signal, and then compares it with the stored sequence number/acknowledgement number, thereby determining whether the acknowledgement signal for the data #1 has been received (\textcircled{4}).

If it is determined that the acknowledgement signal has been received, the sending terminal clears the writing prohibition glag of the n^{th} transmit buffer (\textcircled{5}), and stores next inputted data #2 following in order in the n^{th} transmit buffer and transmits the data #2 to the receiving terminal (\textcircled{6}). In FIG. 4, a case is taken as an example that after the data #1 is stored in the n^{th} transmit buffer, the next data #2 following in order is stored, but if the data #2 has been inputted with the writing prohibition flag of the n^{th} transmit buffer being set, the data #2 cannot be stored in the n^{th} transmit buffer, wherein after the writing prohibition flag of the n^{th} transmit buffer has been cleared, any inputted data will be stored in the n^{th} transmit buffer.

Meanwhile, the writing prohibition flag of the n^{th} transmit buffer is set until acknowledgement for the data #2 is carried out (\textcircled{7}).

According to FIG. 4, it can be seen that the n^{th} transmit buffer has the same address and fixed Ethernet frame size. As shown in FIG. 4, even if the data #1 and data #2 have different size from each other, they are transmitted to the receiving terminal by Ethernet frame of fixed size. Therefore, the present invention need not to assign position of the start pointer of the transmit buffer according to data size or perform complex operations for the pointer in scheduling of the transmit buffer.

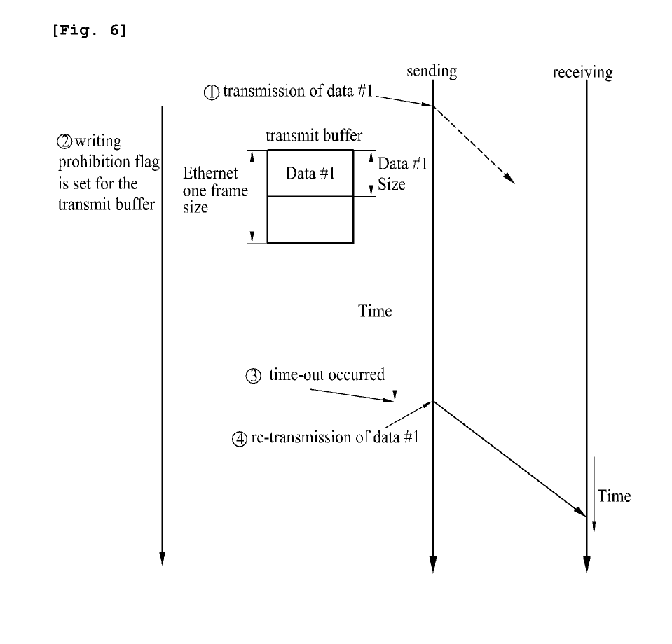

FIG. 6 is a view exemplarily illustrating procedure of re-transmitting the TCP data carried out in the method for processing TCP re-transmission based on the fixed address according to an example of the present invention.

The procedure of re-transmitting the TCP data illustrated in FIG. 6 is carried out in the case that the acknowledgement signal has not been received within a predetermined period of time in the step (\textcircled{4}) of receiving acknowledgement signal for the data #1 illustrated in FIG. 4.

Referring to FIG. 6, after the data transmitting part (50) transmitted the data #1 stored in the n^{th} transmit buffer (\textcircled{1}), the acknowledgement processing part (60) operates a timer for the acknowledgement signal for the data #1 to determine whether the acknowledgement signal for the data #1 is received within a predetermined period of time. As a result of the determination, if time-out is occurred (\textcircled{3}) as the acknowledgement signal for the data #1 has not been received within a predetermined period of time, the acknowledgement processing part (60) instructs the data transmitting part (50) to re-transmit the data #1 stored in the n^{th} transmit buffer.

Responding to the instruction, the data transmitting part (50) re-transmits the data #1 stored in the n^{th} transmit buffer (\textcircled{4}).

Meanwhile, for the transmit buffer storing the data #1, the writing prohibition flag is set until the acknowledgement signal is confirmed by the acknowledgement processing part (60) (\textcircled{2}).

The persons having ordinary skills in the art will understand that various altered or modified examples can be made through the matters described above without departing from the technical concept of the present invention. The scope of the present invention does not reside in the above description, rather in the following claims, and all differences within equivalents thereof should be intended to be included in the present invention.

What is claimed is:

1. A method carried out in a system for processing TCP re-transmission based on the fixed address comprising a transmit buffer initializing part, a transmit buffer scanning part, a transmit buffer data processing part, a transmit buffer lock controlling part, a data transmitting part and a receiving acknowledgement processing part, the method comprising:
(a) a step in which the transmit buffer initializing part sets a plurality of transmit buffers having a fixed address;
(b) a step in which if the kth data of TCP data to be transmitted is inputted, the transmit buffer data processing stores the kth data in the nth transmit buffer of the transmit buffers where writing prohibition flag is cleared, and the transmit buffer lock controlling part sets the writing prohibition flag of the nth transmit buffer;
(c) a step in which the data transmitting part transmits the kth data to a receiver terminal according to instruction from the transmit buffer data processing part, and the receiving acknowledgement processing part determines whether a receiving acknowledgement signal for the kth data has been received; and
(d) a step in which as a result of determination in the receiving acknowledgement processing part, if the receiving acknowledgement signal has been received, the transmit buffer lock controlling part clears the writing prohibition flag of the nth transmit buffer, and if the receiving acknowledgement signal has not been received within a predetermined period of time, the data transmitting part retransmits the kth data stored in the nth transmit buffer,
wherein a start pointer of each of the transmit buffers is fixedly declared and thus each transmit buffer has a fixed address.

2. The method for processing TCP re-transmission based on the fixed address according to claim 1, wherein in the step (a) each transmit buffer is set by Ethernet frame size.

3. The method for processing TCP re-transmission based on the fixed address according to claim 1, wherein the step (b) comprises:
a step in which if the kth data is inputted, the transmit buffer data processing part instructs the transmit buffer scanning part to scan each writing prohibition flag of the plurality of the transmit buffers to search a transmit buffer where the writing prohibition flag is cleared;
a step in which if the transmit buffer scanning part searches the nth transmit buffer where the writing prohibition flag is cleared, the kth data is stored in the nth transmit buffer and the transmit buffer lock controlling part is instructed to set the writing prohibition flag of the nth transmit buffer; and
a step in which the transmit buffer lock controlling part sets the writing prohibition flag of the nth transmit buffer.

4. The method for processing TCP re-transmission based on the fixed address according to claim 1, wherein, in the step (d), if the receiving acknowledgement signal for the kth data has been received, the transmit buffer lock controlling part clears the writing prohibition flag of the nth transmit buffer after searching nth transmit buffer by use of the fixed address of the nth transmit buffer provided from the receiving acknowledgement processing part.

5. The method for processing TCP re-transmission based on the fixed address according to claim 1, wherein, in the step (d), if the receiving acknowledgement signal for the kth data has not been received, the data transmitting part retransmits the kth data stored in the nth transmit buffer after searching the nth transmit buffer by use of the fixed address of the nth transmit buffer provided from the receiving acknowledgement processing part.
